(19) United States
(12) Patent Application Publication
(10) Pub. No.: US 2008/0096174 A1
(43) Pub. Date: Apr. 24, 2008

(54) Tutorial generation unit, multimedia management system, portable apparatus, method of explanation of multimedia management behavior, computer program product

(75) Inventors: Maarten Peter Bodlaender, Eindhoven (NL); Michael Alex Van Hartskamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/598,210

(22) PCT Filed: Feb. 24, 2005
(86) PCT No.: PCT/IB05/50670

§ 371 Date: Aug. 21, 2006

(30) Foreign Application Priority Data
Mar. 1, 2004 (EP) 04100810.3

(51) Int. Cl. G09B 5/00

(52) U.S. Cl. 434/308

(57) ABSTRACT

A tutorial generation unit (100) is introduced for explaining to a user multimedia management behavior of a multimedia item management system (130) arranged to manage multimedia items (164, 166, 168, 169) according to user preferences by means of at least one multimedia management rule (MMR). The tutorial generation unit (100) comprises a processing unit (151), arranged to select at least one selected rule (MMR1) to be explained of the at least one multimedia management rule (MMR), the at least one selected rule (MMR1) being selected depending on a predetermined relevance value (R) indicative of a relevance to the user of the at least one selected rule (MMR1); and—a rendering unit (178), arranged to generate at least one explanation theme (104) comprising at least one audiovisual information presentation signal (108, 110, 112) based on the at least one selected rule (MMR1) to be explained, and arranged to generate a tutorial (102) intended for user observation, the tutorial (102) comprising the at least one explanation theme (104). This tutorial unit may be used e.g. in portable multimedia apparatus that generate song play-lists according to the user's preferences.

The invention relates to a novel unit, system, apparatus, method and computer program product for explaining the multimedia item management behavior of a system from the technical field of multimedia item management systems.

Currently, people are confronted with a bewildering amount of information, and the trend seems to be that this information confrontation will be increasing. In particular, for multimedia items of interest to a person, such as e.g. songs, in the current state of the art this person has the options of:
1) passively taking in everything presented to him, which occurs e.g. when he listens to the radio;
2) actively browsing for individual multimedia items, e.g. on the Internet; or as an intermediate between these two
3) relying on an automatic multimedia item management system, which, by taking into account rules corresponding to preferences of the user of this system, is able to preselect a collection of items which is of particular interest to that user, while rejecting all the non interesting ones.

To be accurately adapted to the user preferences, a lot of rules are required, making the multimedia item management system complex. It is typically difficult to train such a complex system, because of non-linear interactions between rules, inappropriateness of rules, etc.

It is a disadvantage of the multimedia item management systems of prior art, that a user typically has to train the system by studying the entire management/preselection process on a multimedia item-by-item basis. This might be very time consuming and frustrating, and if the system does not converge to the user-preferred management behavior relatively easily, the time lost in optimizing the system may be far greater than the time gained from the automatic management. Furthermore, because of this huge effort required in analyzing the management behavior, a user cannot quickly check whether a set of rules—e.g. a personal play-list generator software optimized according to particular predetermined user preferences, which he purchases e.g. on a data carrier—is really appropriate to him, or more appropriate than other personal play-list generators on offer.

It is an object of the present invention to provide an improvement for existing multimedia item management systems.

This object is realized in that a tutorial generation unit is provided, for explaining multimedia management behavior, of a multimedia item management system arranged to manage multimedia items according to user preferences by means of at least one multimedia management rule, the tutorial generation unit comprising:

a processing unit arranged to select at least one selected rule to be explained of the at least one multimedia management rule, the at least one selected rule being selected depending on a predetermined relevance value indicative of a relevance to a user of the at least one selected rule; and

a rendering unit, arranged to generate at least one explanation theme comprising at least one audiovisual information presentation signal based on the at least one selected rule to be explained, and arranged to generate a tutorial intended for user observation, the tutorial comprising one or more explanation themes.

The processing unit selects for explaining, one or more rules from the total set of rules of the multimedia item management system belonging to a particular explanation theme, e.g. the subset of rules that regulate the selection of salsa music. Each of the possible explanation themes has a relevance value, e.g. a relevance value of the first rule of the selected rule combination, the relevance of the most important rule of the rule combination, or a total relevance of the rule combination calculated from the relevances of all rules in the rule combination. Even if only one rule is selected for the explanation theme according to its relevance, additional related rules may be explained in the same theme. The explanation theme, i.e. its combination of rules, with the highest relevance is the most relevant to explain to a user, i.e. should typically be explained first. The rendering unit then associates presentation signals (e.g. a video signal for displaying a graphical symbol on a region of a display) with the rules. This presentation typically occurs during consecutive time instants, e.g. for the case where a static image is displayed, this may be done so until the user clicks it away or for a non-interactive tutorial until a predetermined amount of time has lapsed. A single signal may be associated with a single rule (such as a textbox containing a textual representation of the rule), or a signal may correspond to several rules (such as a list of song titles being selected under the combining action of three rules), or lastly, several signals may be generated for a particular rule or rule (sub)combination (e.g. a textual and graphical representation).

A simple example of the tutorial just explains one or more rules as a single explanation theme presented for an indefinite amount of time, comprising e.g. the selected rules described in text boxes and the resulting multimedia item selection presented in a list of textual identifiers. A somewhat more advanced tutorial comprises a number of explanation themes, presented sequentially, each during an associated time interval.

An embodiment of the tutorial generation unit comprises a user interface unit, arranged to substitute at least one of the at least one information presentation signals of at least one of the at least one explanation themes based on user input. It is advantageous if the user can follow the tutorial at his own pace. Hence the user can e.g. change a single signal in a particular explanation theme, e.g. slide the slider of a scroll bar widget, or he can switch to the next or previous explanation theme, or any other explanation theme, in which case all signals of the current explanation theme are substituted by the signals of the other explanation theme. The substituted signals show the particular multimedia management aspect as currently desired by the user.

It is advantageous to arrange the rendering unit so that it is able to present explanation themes of different types, such as:
a) a movie of pictures to be presented during a predetermined time interval, the pictures comprising at least one sub-picture image signal, each of the at least one sub-picture image signals comprising a graphical representation corresponding to the at least one selected rule;
b) an information presentation image presenting information corresponding to the at least one selected rule, with clickable hyperlink regions, which hyperlink regions when clicked initiate the display of a different information presentation image corresponding to a different explanation theme;
c) a collection of audio sequentially played snippets, each snippet corresponding to the at least one selected rule; and
d) scrolling text containing identifying information of at least one multimedia item selected according to the at least one selected rule.

The movie-type is interesting to explain during a short time interval the most important multimedia management behavior of the multimedia item management system to a user who has little time to spend, whereas the audio presentation is useful for being used in or on apparatuses without a display.

In an embodiment of tutorial generation unit, the processing unit is further arranged to adapt at least one rule of the at least one multimedia management rules of the multimedia item management system based on the user input.

If a user is going to be explained in detail the multimedia management behavior of the multimedia item management system, it is advantageous if at the same time that he is studying this system he can also adapt its rules.

It is advantageous if the processing unit is further arranged to associate a presentation time interval Dt with the at least one explanation theme, indicating the time interval during which the collection of information presentation signals of the at least one of the at least one explanation themes are to be presented to the user. In this way the user can be explained the behavior in a fast manner, whether in an interactive or non-interactive tutorial.

Furthermore, the processing unit may be further arranged to:

comprise a predetermined total presentation time interval Ttot; and

allocate explanation themes and associated presentation time intervals on the basis of the relevance value R of at least one of the at least one selected rules, and the total presentation time interval, so that the user's attention is mostly focused on those rules that are of most interest to him.

In various embodiments, processing unit may be further arranged to determine the relevance value R of a single selected rule or a combination of selected rules on the basis of one or more of the following:

a percentage of songs selected or rejected according to the selected rule or rules;

a degree of correspondence between the selected rule (MMR1) or rules and a user preference rule;

a manually assigned relevance of the selected rule or rules;

a date of introduction or modification of the selected rule or rules;

a date of previous explanation of the selected rule (MMR1) or rules;

a predetermined kind of management action the selected rule or rules predominantly contributes to; and

the origin of a rule (e.g. introduced by MTV after a deal with Sony to promote more of its music. The user way want to know this and give his explicit agreement).

The processing unit is advantageously further arranged to explain a subset of the selected rules and/or vary parameters of a subset of the selected rules. I.e. it may e.g. first show the influence on the selection behavior of the first rule, then of the second rule etc., and while explaining the influence of the second rule, it may do so in dependence on various values of this rule's parameters.

In further embodiments of the tutorial generation unit, the processing unit is further arranged to perform a mathematical analysis on an equation specifying a combined action of a set of selected rules, in order to explain to a user aspects of the behavior of the equation. In this way even mathematically inexperienced users can be taken through the intricate behavior of the multimedia management.

It is advantageous if the tutorial generation unit further comprises an interface unit arranged to receive or retrieve information from an external information source of at least one of the types:

human generated information describing a multimedia item;

human generated information describing a multimedia management rule or a combination of multimedia management rules; and

human generated information specifying a particular presentation signal related with a multimedia management rule.

This way very user-understandable tutorials can be presented by the tutorial generation unit.

Embodiments of the tutorial generation unit are arranged to receive data on user preferences from a user preference determination unit, in which way the tutorial can be better optimized to particular user preferences, such as e.g. his liking of salsa. The user may manually enter his preferences in this user preference determination unit or it may actively monitor different user behavior aspects.

The multimedia item management system and tutorial generation unit may be integrated in a multimedia management system, both parts possibly being located in separate internet-connected apparatuses in different countries, or in a single apparatus.

Furthermore, a method of explanation of multimedia management behavior, of a multimedia item management system arranged to manage multimedia items according to user preferences by means of at least one multimedia management rule, is provided, the method comprising:

selecting at least one selected rule to be explained of the at least one multimedia management rules, at least one of the at least one selected rules being selected—depending on a predetermined relevance value R indicative of a relevance to a user of the at least one selected rule; and

generating at least one explanation theme for consecutive time instants comprising at least one audiovisual information presentation signal based on at least one of the at least one selected rules to be explained, and out of that generating an interactive tutorial intended for user observation, the interactive tutorial comprising one or more explanation themes, as well as computer program products corresponding to the method or any embodiment of the tutorial generation unit or multimedia management system comprising it.

These and other aspects of the units and systems according to the invention will be apparent from and elucidated with reference to the implementations and embodiments described hereinafter, and with reference to the accompanying drawings, which serve merely as non-limiting illustrations. Optional components are shown dashed.

In the drawings:

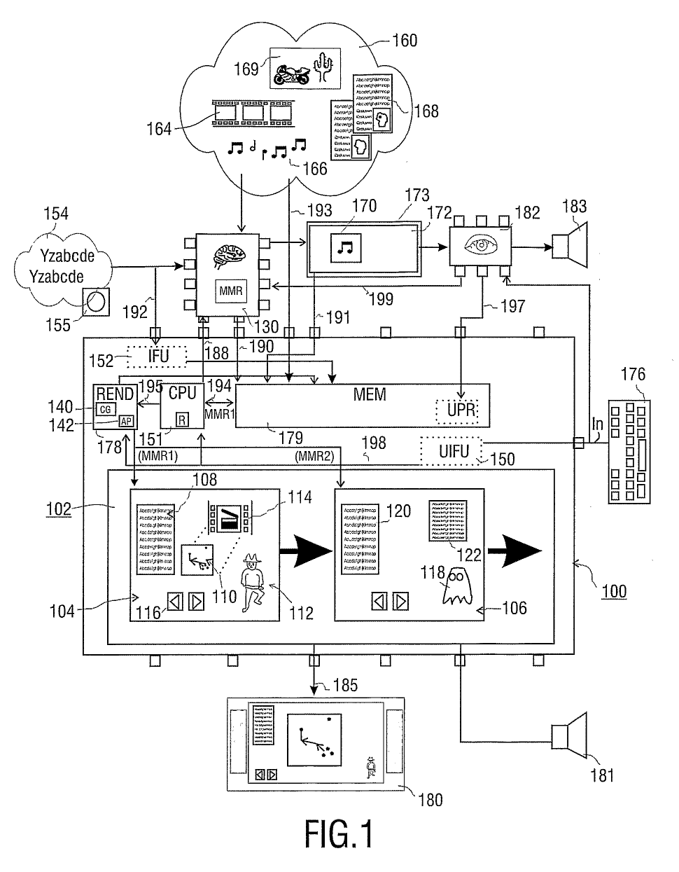

FIG. 1 schematically shows an interactive tutorial generation unit in a typical configuration;

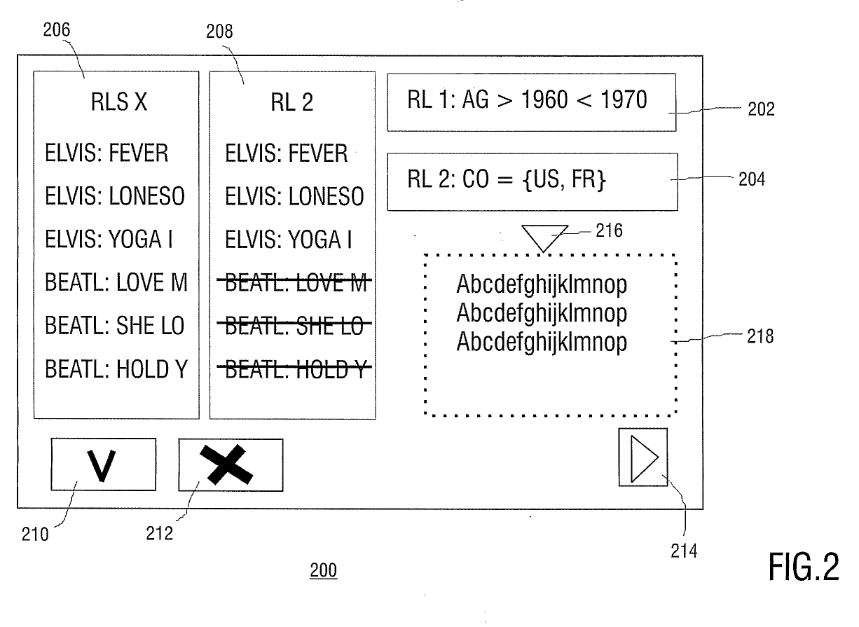

FIG. 2 schematically shows a relatively simple embodiment of an explanation theme;

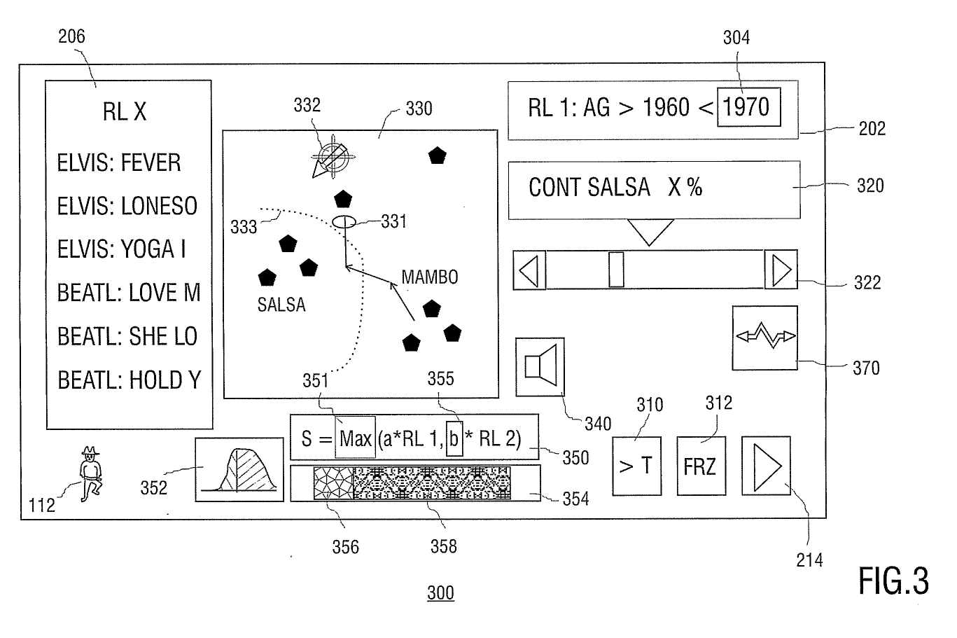

FIG. 3 schematically shows a more advanced embodiment of an explanation theme;

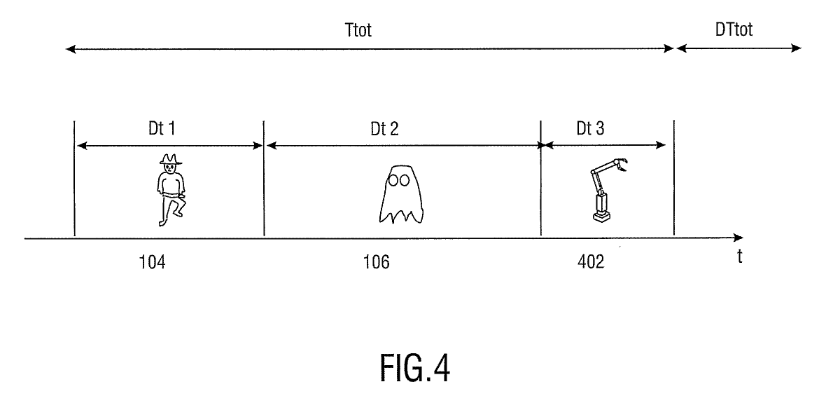

FIG. 4 schematically shows a timeline showing three presentation intervals of movie-type explanation themes; and

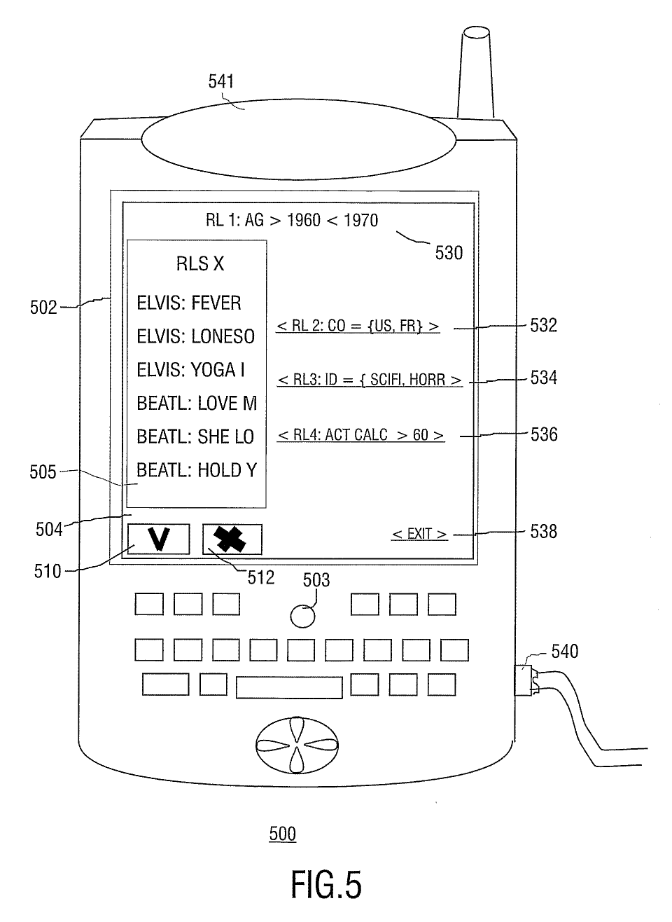

FIG. 5 schematically shows a portable apparatus displaying a “hyperlink image” explanation theme.

In FIG. 1, a tutorial generation unit 100 is shown. The purpose of this tutorial generation unit 100 is to generate a tutorial 102 explaining the multimedia management behavior of a multimedia item management system 130, which may be comprised in the same apparatus as the tutorial generation unit 100 or in a different apparatus. In the case where e.g. a data carrier or storage location on a network server contains multimedia item management software, or solely rules, for application in a generic multimedia item management system, which is e.g. a generic processor of a home PC, the tutorial generation unit 100 is able to explain the behavior of such a “virtual” multimedia item management system.

For simplicity the description will disclose the tutorial generation unit 100 in an application in which the multimedia items are songs 166 (or movies 164), selected by the multimedia item management system 130 and put in a so-called play-list 172 as is known from prior art of e.g. MP3 players, in which case the multimedia item management system 130 may be called a personal play-list generator. The play-list may be constrained to have fixed length, e.g. if only a small amounts are carried along by the user (e.g. in his watch), their relevance may need to be very high, since any inappropriate song decreases the practical amount of available songs.

It should be clear to the skilled person that using the technological components disclosed by these exemplary embodiments, in addition to songs 166 further multimedia item types may be selected, or otherwise managed such as classified in different folders, or reordered, e.g.:

movies 164 [a sequence of images creating the illusion of motion], in which case the play-list may e.g. be constructed for an evening of entertainment, comprising two motion pictures [a particular cinematic narrative, e.g. a science fiction motion picture] separated by a set of news movie clips.

Text paragraphs 168, e.g. in a construction explaining a particular topic like “The koala” in a manner optimized for a particular user, in an application such as an adaptive encyclopedia or optimized learning. E.g. the koala may be a sports team, and the user may discover in the tutorial that the multimedia item management system 130 is erroneously presenting a lot of biological paragraphs about the animal koala, because it erroneously assumed a preference of the user for biology from his accessing of such information on a single previous occasion.

Still pictures 169, e.g. a holiday slide show may be presented differently based on whether grandmother or the high school friends are visiting (the user preferences in this case being one or more selected from a set corresponding to possible visitors).

Actions, elements or story lines of a game, providing the user with a game optimized to his likings (e.g. if the user likes action games, more fight scenes with preferred characters may be included, or for another users more puzzles or different game environments may be provided).

Personal assistant information, e.g. suggesting the user restaurants of his liking (categories being price, variety, . . . ) in the vicinity of his present location.

Audio/visual offers of e.g. holiday possibilities or computer parts, providing the user with an adaptive advertising or adaptive search.

These multimedia items are present in a multimedia item collection, which is typically the collection currently stored on the user's home personal computer, home storage server, a friend's storage server, the internet, etc.

In all the above, the selection happens in accordance with user preferences, which can be associated with the multimedia items. Prior art discloses a number of categories of associating describing information, e.g.:

attaching metadata, e.g. a tag, to the item (e.g. a Radio Data System field, or MP3 ID3 tag);

identifying the item (e.g. by means of fingerprint extracting) and looking up information about it in a database, e.g. web pages of a user community or special interest group.

measuring a physical property of a multimedia item, e.g. the tempo or loudness of a song, the amount of action/motion in a movie segment, etc.

This describing information can be used by a particular user to formulate multimedia management rules MMR and combinations thereof, to enable the multimedia item management system 130 to optimally select or in general manage the content, e.g.:

Horror motion picture selection rules:

Rule 1: The motion picture should be recent, later than 1990

RL 1: TAG_AG>1990 [a numerical tag being checked for its value]

Rule 2: There should be multiple screams in the motion picture

RL 2: # { ALGO_SCR[I]>0.8}>=6[an algorithm ALGO_SCR analyses the sound track based on loudness, spectral content, etc., and identifies the likeness that in a time interval a scream occurred, values higher than 0.8 probably representing screams, and lower values indicating other sounds; at least 6 screams should occur for it to be a good horror motion picture according to the user]

Rule 3: The selection is further filtered by checking for tags which very likely indicate that a horror motion picture is selected, e.g. based on a typical actor

RL 3: (TAG_TYPE=HORROR) OR (TAG_ACTOR=BELA LUGOSI)

In this simple example above, in rule 3 an “error” is made—which may not be due to the user if the rules are obtained from somewhere else. Bela Lugosi is indeed an actor in horror movies but not in the nineties. If rule 3 contained an AND condition, very few items according to the user's preference would be selected, and the user would not know “why”. This illustrates the non-linearity of the selection behavior of the multimedia item management system 130. E.g. in an AND construction the selection potential of a large set of valid rules can be nullified by a single inappropriate rule, like the “Bela Lugosi” example. And the tricky thing is that this rule may be an inconspicuous left-over, e.g. from the previous selection when the user was interested in older horror motion pictures, or shared by a fellow horror aficionado who likes a broader range of horror. For a large set of rules required in a specific query on a large database with very variable item kinds, such non-optimal rules are relatively likely to occur.

A straightforward way of analyzing the multimedia management behavior is checking the myriad of selected multimedia items according to these rules (or a subset if it is representative). The user can then change a rule and check again all the ensuing selected multimedia items according to the new rules. By using such an analysis strategy the user is probably not going to get much wiser as to which rule(s) or combination of rules is to blame. Not only will he spend a lot of time looking at less relevant rules, but in particular he will not grasp the intricate interaction between the rules. In all likeliness he is only going to waste a lot of time.

Not only do prior art systems focus on the checking of single ensuing items, they are also user driven. The user is supposed to be knowledgeable of the kind of information and the manner in which to access it, i.e. he actively browses the behavior of the multimedia item management system 130. E.g. in a prior art database interface generator, the user may design an interface for accessing relevant fields according to his preference, but the appropriateness of this interface is verified by checking the returned items. The internal workings of the database selection, in particular the rejected items, and the reasons for rejection, are not perceived by the user in such a verification strategy. The tutorial generation unit 100 is arranged to automatically generate a tutorial of interesting rules (i.e. select and explain the rules of the behavior themselves), and how exactly those rules regulate the multimedia item management, i.e. without a necessity of user interaction, although the user may want to interact with the tutorial presentation.

Furthermore, a user may only have a limited time budget for verifying the behavior of the multimedia item management system 130. Instead of sequentially going through e.g. all rules of the underlying software code, which is possible with prior art systems like debuggers, or visual programming environments such as the Khoros environment [details of which are present at Khoral Inc.'s webpage http://www.khoral.com], the tutorial generation unit 100 presents the explanation in a prioritized way, e.g. first explaining which rule or set of rules generated most of the songs, or those songs the system knows the user currently—e.g. in the evening—has an interest in. Even if the amount of time to spend of the user is not exactly fixed, i.e. the total presentation time of the tutorial may be unlimited, the user is still presented with the most relevant multimedia item management behavior first.

A tutorial 102 is composed of a number (one or more) explanation themes. E.g. FIG. 1 schematically shows movie-type explanation themes: two theme visual signals (104, 106) are schematically shown, their temporal presentation order drawn with arrows. A first explanation theme 104 is e.g. “danceable music” or “western motion pictures”, in which the multimedia management rules are explained which contribute to this theme, while a second explanation theme 106 may be “scary music” or “horror motion pictures”. The theme may also be selected more specific, e.g. the following example describes a way to select danceable salsa music of the kind the user is interested in.

Note that in the present description, a distinction is made between a single rule—which may in itself be the result of a complex algorithm like a scream detector—and a rule combination. E.g., the multimedia item management system 130 may have a combination of rules for detecting a salsa song:

SAL=F_{SAL}(RL 1, RL 2, . . . , RL n1), which is a mathematical formula, e.g. a weighted linear sum of the numerical outputs of the separate rules.

E.g., rule 1 (RL 1) detects the 3-step dancing rhythm, rule 2 detects the presence of a typical salsa drum introduction, and rule 3 checks whether the title or song contains mainly Spanish words. A high value of the resulting SAL indicates that it is likely that the song is a salsa song.

Subsequently, the user may want to combine this combination of rules with another rule, acting as a post-filter on the already selected salsa songs: “because he wants to dance quickly, he is looking for fast tempo salsa”:

RL 4: BPM>180, in which BPM stands for beats per minute.

If the selection rules are based on thresholding, e.g. employing a threshold value Tₛ above which a song is characterized as salsa, and producing Booleans, the above post-filtering is easily realized with an AND combination.

FAST SALSA=(SAL>Tₛ) AND (BPM>180) [Eq. 1]

Songs for which Eq. 1 yields a Boolean result equal to TRUE (1) are retained in the selection, while other songs are rejected.

It should be clear to the skilled person that other rules can be used and are known from prior art, e.g. employing fuzzy logic.

A processing unit 151 is arranged to select and analyze rules MMR1 or combination of rules. Typically to enable rule selection, the multimedia management rules MMR of the multimedia item management system 130 are copied preferably on the first possible occasion (such as the first connection to the tutorial generation unit 100) from the multimedia item management system 130, along connection 190 into memory 179. Furthermore, the processing unit 151 has the capacity to analyze the multimedia items (e.g. songs 170) present in a currently generated play-list 172, typically stored in a memory 173, and map this selection to the multimedia management rules MMR copied in memory 179. This may be done by classifying the songs 170 in the play-list 172 (or another selection of songs according to the current multimedia management behavior of the multimedia item management system 130) a posteriori (e.g. after a subset of them has been downloaded via connection 191 to memory 179 for characterizing their signal properties such as tempo) by the processing unit 151 according to a number of aspects. These aspects may be supplied by the user (he has inputted in the system on a previous occasion that he likes to dance), or by an external information source 154, such as a database updated by the music television station MTV, etc.

The processing unit 151 may at the present time explain the danceability of the songs, because it has user preference rules UPR, which state that the user often likes to dance in the evening. Analyzing the current play-list, or a typical play-list which would be generated by the current multimedia item management system 130 behavior as codified by the multimedia management rules MMR, taking subsets of multimedia items 164, 166, 168, 169 from the multimedia item collection 160 via connection 193, the processing unit 151, employing e.g. mathematical clustering techniques on the describing information, draws the conclusion that the play-list contains predominantly danceable music of two subcategories, namely “salsa” and “mambo”. According to an internal rule, the processing unit knows that it is more relevant to the user to explain the subcategories separately, since the user then obtains more detailed information by which he can judge, and if required fine-tune, the multimedia item management system 130 behavior. Hence the processing unit selects rules MMR1 (see example above) for a first explanation theme 104, namely the generation of the salsa danceable music.

This is an example of attributing a relevance R to a multimedia management rule MMR, which is based on analysis of the number and distribution of songs in the play-list 172 (or any list of songs conforming the selection behavior), as well as on user preference rules indicative of the relevance of particular classes of multimedia items to the user.

The relevance R of a rule MMR may be determined on the basis of a percentage of songs selected or rejected according to the selected rule (MMR1) or rules. E.g., a rule that contributes mostly to the selection of songs (i.e. a large percentage of the songs have been selected at least partially due to the influence of this rule MMR) may be allocated a high relevance according to one type of relevance allocation strategy. Vice-versa, rules which generate only a few of the songs, or a small sub-cluster of songs with particular properties may be allocated a high relevance value, since according to this strategy “specific” rules are worth explaining.

Alternatively or additionally, the relevances R of the rules MMR (and hence also the selected rules MMR1, MMR2 retained for explanation because of their high relevance value R) may depend on a degree of correspondence between the rule MMR or rules and a user preference rule UPR. E.g. a user preference determination unit 182 may analyze which songs—i.e. songs with which properties—are actually listened to by the user, or listened to from beginning to end, or even multiple times. Hence the processing unit 151 can determine that salsa is more important to the user than techno, and explain the salsa management with a higher priority. Alternatively, the processing unit 151 may proactively realize that inappropriately many uninteresting techno songs are currently being selected for the play-list 172, and with priority explain to the user why this is so. This user behavior may further be sub-divided on time of day, time of the year, current situation (e.g. the user has indicated to the tutorial generation unit that friends are visiting because it is “his birthday”), etc., and the processing unit 151 may adapt its relevance allocation accordingly.

The relevances R may also be allocated on the basis of what was already explained, when and how, e.g. a date of introduction or modification of the selected rule (MMR1) or rules or a date of previous explanation of the selected rule (MMR1) or rules.

Relevances R may also be assigned manually, by the user or other persons e.g. in a community of salsa aficionado's.

The relevances R may also depend on the kind of management action the rule predominantly contributes to, e.g. the user may predetermine interesting management actions like “put in garbage bin after 2 weeks”, “reserve for weekend”, etc., and then observe why a lot of interesting songs end up in the garbage bin.

It should be clear that apart from the above examples, the skilled person can program other strategies of interest.

A total relevance R for a rule combination can be calculated mathematically. The mathematics used by the processing unit 151 for deriving a relevant rule combination to explain can be found in the prior art of optimization, e.g. of hill-climbing or genetic algorithms, or simulated annealing, etc. A neighbor explanation for hill-climbing optimization can easily be obtained by replacing one of the rules.

A rendering unit 178 is arranged to produce signals corresponding to the selected multimedia management rules MMR1. The rendering unit 178 may comprise a computer graphics processor 140, which is arranged to produce signals (e.g. initially pixels in a video memory which are converted to television standard video signals, as is common general knowledge from prior art) usable in each interchangeable composition, of types such as:

a list representation 108, 120, showing e.g. a subsets of the songs/items in the play-list selected by a particular rules currently being explained;

a textbox, e.g. comprising additional explanations (textual information textbox 122) or a rule (first rule textbox 202—see FIG. 2);

a graphical representation 110 of one or more selected songs/items;

a graphical representation 354, FIG. 3 of one or more selected rules MMR1; and

a widget representation 322, FIG. 3 of a selected rule MMR1 or combination of rules [a widget is a combination of on the one hand a graphical presentation and on the other hand corresponding program code to perform a specific function; (N.B., if no user interaction is possible only the graphical part is manipulated by the processing unit 151)].

The computer graphics processor 140 is further arranged to generate signals for other graphical elements of the presentation theme, such as a theme identifier 112, 118.

The simplest embodiments of the tutorial generation unit do not allow user interaction, i.e. they present the tutorial to a passive user who cannot interact with the tutorial, except possibly for a discontinuing of the tutorial before its predetermined ending. E.g. a movie-type explanation theme 104, 106 tutorial 102 presentation is generated by the rendering unit 178, as shown in FIG. 1. The processing unit 151 allocates to each explanation theme 104, 106, 402 a presentation time, by evaluating a set of heuristic rules indicative of the relevance of the theme to the user. E.g. (as illustrated in FIG. 4) during a first time interval Dt1, the contribution of “western motion pictures” (104) to the play-list is explained, followed after expiry of this time interval Dt1 by an explanation of the selection behavior of “horror motion pictures” (106) during a second time interval Dt2, and lastly followed by an explanation of the selection of “scientific documentaries” (402). Such a movie-type theme comprises video picture (sub)signals to be shown on a display 180 (connected with a video signal connection 185), in which at least a part of the (sub)signals changes, giving the illusion of motion, which motion is used in the explanation. E.g., as shown in FIG. 2, a multimedia item management rule in a rule textbox 202 may be highlighted, and an action of the rule may dynamically be indicated, e.g. by crossing through song titles in a list representation 206, which under the action of the rule are rejected from or not contributing to a play-list. Similarly, as shown in FIG. 3, the processing unit may instruct the rendering unit to dynamically adapt a slider of a scroll bar widget 322, in correspondence to a range scanning variation of numerical values of a rule, to explain the impact of this rule. Which types of song are hence selected in the play-list can be shown in a dynamical graphical manner in a graphical representation 110, 330 of e.g. a song parameter state space. By playing such a movie, numerous aspects of the behavior of the multimedia item management system 130 regarding a particular theme is explained.

Cheap or portable devices may even have less rendering capacity, e.g. a small MP

3 player or jewel electronic gadget may have a small display or no display at all. A variant of the processing unit 151 and rendering unit 178 for a small display only scrolls along the screen a textual representation of the rule and a number of titles or other textual representations of correspondingly selected songs. A variant of the processing unit 151 and rendering unit 178, comprising for such purpose an audio processor 142, for devices without a display, plays audio snippets corresponding to rules and audio snippets of the selected songs, e.g. 5 seconds introduction or the refrain, in the case where the processing unit 151 is equipped with a refrain detector, e.g. employing repetitive pattern detection. The rule describing snippets may originate from text-to-speech generation in high-end tutorial generation systems (audio presentation is also useful when the display has ample video display capabilities) or from a data source. E.g., the tutorial generation unit 100 may comprise an interface unit 152 for accessing the external information source 154. This external information source 154 may be received via an external source connection 192, e.g. telephony connections or the airways in broadcasting. The external information source 154 may e.g. be the MTV Internet database server, in which case the describing snippets may be e.g. remarks by a DJ. The database may contain different types of information according to an MTV classification, e.g. specific multimedia management rules, additional information about their behavior (e.g. “use the mambo-rule set to obtain relatively relaxing mambo”), graphical ways to explain the behavior of the rules (e.g. a two-dimensional state space widget with two predefined axes like tempo and “mood”), etc. In the case where the external data source 154 is a data carrier 155 such as a disk or memory stick, the interface unit 152 may comprise a disk drive etc.

In the more advanced embodiments, the user may interact with the tutorial by means of a user interface unit 150 arranged to receive and parse input In from a user interface apparatus 176 such as a keyboard, voice control input, etc.

E.g. in case a time interval Dt1 for presentation of an explanation theme 104 is too short, the user may return to it, allocate extra time to the presentation etc. In case the tutorial generation unit is arranged to intendedly present the movie-type tutorial 102 in a predetermined finite total presentation time interval Ttot, if a user adds presentation time to the first explanation theme 104 presentation, a equal amount of time may be deduced from subsequent themes. Alternatively, the total presentation time interval Ttot may be stretched up to a predetermined overtime amount DTtot.

The processing unit 151 may be further arranged to allow more sophisticated user interaction, such as e.g. allowing the user to scroll the slider of the scroll bar widget 322 hence and forth to his likings. Or, the user may click a “start movie”-button 114, which initiates the popup of a graphical representation 110 of how the selected songs depend on the (variation of) the selected rules.

Finally, in a very useful embodiment of the tutorial generation unit 100, the user is able not only to in detail study the behavior of the multimedia item management system 130, but at the same time change the behavior of the multimedia item management system 130. For this, the processing unit 151 is arranged to speak the “protocol” for changing rules of the multimedia item management system 130, which is connectable via a control connection 188. Various user interfaces can be designed for this, e.g. the user can set the scrollbar widget 322 slider to a position yielding a song selecting behavior of his liking, and then push a “download” button 370 to transfer these multimedia item management rule settings to the multimedia item management system 130.

A user preference determination unit 182 may be connected to the tutorial generation unit 100, which user preference determination unit 182 is arranged to monitor user behavior and formulate user preference rules UPR which can be stored in the memory 179 via connection 197. Embodiments of the user preference determination unit 182 may comprise:

a statistical unit for analyzing which items from the play-list are actually played (fully) by the user;

a clock which records the times at which the user plays particular multimedia items;

more complex user monitoring apparatuses, such as a camera and video processing unit monitoring activities from the user.

This user preference determination unit 182 may be incorporated in various apparatuses (e.g. the user's personal computer) which apparatuses may communicate the behavior to a central unit or directly to the memory 179. From this user monitoring user preference rules emerge such as e.g. “in the evening the user likes RELAXING music”, relaxing being defined in a separate rule combination for this user as “slow tempo, no loud parts, no strong beat, preferably classical or nature sounds”. These rules are obtained by classical mathematical data analysis techniques such as e.g. clustering in parameter space.

In FIG. 2 a simple explanation theme 200 is shown for quick behavior verification or correction, to be employed if the user has little time to spend.

Shown are a number of selected rules in textboxes 202 and 204, indicating respectively the year of a song and the country of origin.

The processing unit may be arranged to execute a translation method, for translation the internal rule description to a more readable form, e.g. instead of presenting the text “RL 1: AG>1960<1970”, the following text may be presented:

“THE songs ARE SO CHOSEN THAT THEY ARE more recent than 1960 AND older than 1970”. How to generate such text is well-known in the field of artificial intelligence.

A third list 206 representation 206 shows typical selected songs selected by all selected rules corresponding to the particular explanation theme (in the example “great sixties songs”) except a rule under scrutiny at the momentary presentation of that theme (in the example the country of origin). A fourth list 208 shows which songs are rejected by the application of the rule under scrutiny. The user can easily perceive that the Beatles' songs which according to his preferences would perfectly fit in his “sixties” theme are all rejected because the country Great Britain is not comprised in the rule. In a more advanced explanation theme interface, the user would have an opportunity to quickly correct this by adding a country code to the rule, e.g. from a selector list. In this simple interface for quick identification however, the user can only agree with a rule by clicking an “agree” button 210, maintaining or enforcing (e.g. if the rule is selected on a probabilistic basis, or if a threshold determines the contribution of the rule to the selection) the rule under scrutiny, a “reject” button 212, eliminating the rule from the rule combination (typically an AND for such simple explanation theme interfaces), or ignoring this theme entirely, by clicking a “next theme” button 214. A few “expander” buttons 216 may be present, popping up e.g. a textbox 218 with textual information (e.g. received from MTV) further explaining a rule, such as e.g.: “This rule selects songs only if the artists have a nationality of one of the countries in the list. Country codes may be obtained from . . . Beware, this rule has a strong selecting power, nice sounding songs may be rejected because . . . ”. Further explaining text may be appended, such as e.g. when you modified the rule combination adding this rule. The text further explaining what happens in the multimedia management and why in textbox 218 may also be present permanently.

In FIG. 3, a more complex explanation theme interface is shown, which may typically be used by a tutorial generation unit 100 enabling a far-reaching user interaction with the multimedia item management system 130 multimedia management rules. Again textbox 202 displays textually a selected multimedia management rule MMR1, however, now this rule can be adapted to check its influence on the multimedia item selection behavior of the multimedia item management system 130, e.g. the “end year” may be modified in a text reading widget 304. If an “end year” different from 1970 selects better songs, the user may push the “download” button to actually change the multimedia management rule MMR1 or combination of rules in the multimedia item management system 130. Similarly a second rule in textbox 320 (e.g. a percentage of salsa-metatag songs in the play-list) may be adapted with a scrollbar widget 322. Instead of just explaining the effect of enabling a specific rule like the “country of origin” rule illustrate with FIG. 2, the scrollbar widget 322 can be user by the processing unit 151 to explain the effect of varying a rule parameter, such as the percentage contribution of salsa songs or an average tempo of selected songs. User-initiated or automatic adaptations of multimedia management rules may also be presented in a graphical representation, e.g. a state space diagram. By varying on or more parameters/rules, a typical selected song, according to the current (modeled) multimedia management behavior of the multimedia item management system 130 with the currently modified rules, may be indicated with a “selected song” indicator 331 (which may correspond e.g. to the mathematical average of typical songs currently selected), so the user can see when a song leaves the cluster “mambo” and enters the cluster “salsa”, which region in indicated with a graphical indication 333 e.g. mathematically derived from the cluster variance. A user may also discover the state space with a cursor 332, which optionally adapts multimedia management rules, if the memory 179 contains rules linking positions in the state space with e.g. parameters, occurrences or mathematical combination equations of multimedia management rules MMR1. The user may click a “play” button 340 to actually listen to (part of) a song closely corresponding to the ones currently selected and/or indicated with the graphical indication 333, by evaluating a distance metric.

List 206 in this example is a clickable list widget. When a user clicks on a song title, more particular information about the song in relation to the explained rules is given in a pop-up window (not shown). E.g.: “Song 3 is selected because it is from 1961 thus retained by rule 1” and “Rule 5 allows at most 3 songs from each individual year, this song being the 3^{rd} selected”. Or when the user desires an explanation of a song rejected from the current play-list (e.g. shown as crossed out): “The song was selectable because of its BEAT and COUNTRY OF ORIGIN, but finally rejected because you LISTENED TO IT TWICE THIS WEEK”. The algorithms for presenting this textual information in an agreeable human-readable form may be supplied together with the rule, e.g. from the MTV site.

Rule combinations may be more complex than a simple AND combination, and hence their mathematical formulations may be more difficult to analyze by the user. The processing unit may be arranged to execute a mathematical analysis method on an equation 350 specifying how a set of selected rules MMR1 act in combination. E.g. the combination may be an additive equation:

RES_{—}1=a* RL_{—}1+b*RL_{—}2; [Eq. 2]

In which a and b are weight constants, and the rules yield numerical values, e.g. between a lower and upper limit (mathematically specified employing the principles of probability, and/or fuzzy logic, measure theory, etc.). The numerical values may be the result of the evaluation of a function on a parameter such as e.g. the song tempo, which function may be monotonic, Gaussian, etc. A user should have the opportunity to verify that the range of values of RL_2 is far greater than that of RL_1, and the scaling factor a does not take this into account optimally, hence RL_1 hardly contributes to the result.

In the combination of rules yielding the desired multimedia item management behavior, a number of mathematical evaluations may occur sequentially, one intermediate condition e.g. specified as:

S=MAX(a*RL_{—}1; b*RL_{—}2) [Eq. 3]

Function selector box 351 allows the user to select a different mathematical equation, e.g. something behaving more appropriate than a MAX function, while parameter adjustment widget 355 allows the modification of a parameter.

To allow the user to do these modifications wisely, it is advantageous if the processing unit 151 and rendering unit 178 are adapted to give a graphical overview of the behavior of these equations, e.g. with a functional analysis graph 354. When illuminating the behavior of equation 1, the functional analysis graph 354 may be a range bar, which indicates the range of possible or actually occurring in the multimedia item collection 160 values of rule 2. A graphical property, e.g. color, indicates that over most of the range 358 typically rule 2 dominates over rule 1. Only at the lower end of the range 356, the first rule has any chance of ever contributing. A statistical graph 352 may also be presented, indicating e.g. probability of selection of songs over a parameter range and which rule or rule aspect contributes. E.g. if the parameter is tempo, and the rule is “country of origin”, the statistical graph 352 may immediately make evident to the user that Argentinian Salsa is faster than Mexican Salsa. They user wanting fast salsa may act by replacing Argentina with Brazil and check the graphs again.

Different variants of buttons are shown which enable the user to change the presentation flow of time from that originally intended by the tutorial generation unit 100. E.g. a “more time” button adds a predetermined amount of seconds to the presentation time interval Dt1 of the current explanation theme 104. A “freeze” button stops the transition to the next explanation theme 106 of the tutorial 102.

FIG. 5 shows an example of a “static image”—type explanation theme 504, e.g. a webpage format with clickable hyperlink regions. The generation of this tutorial may actually run on a remote internet server in the case where it is used to explain purchasable multimedia item management rule sets to a potential buyer (note that the different components described in this description, e.g. the multimedia item management system 130, tutorial generation unit 100 and user preference determination unit 182, or even some of their modules may run on different apparatuses, e.g. internet servers), or it may typically be generated inside an apparatus of the user, such as e.g. a portable device like a mobile phone or pocket PC or the user's home PC. Shown is such a portable apparatus 500, with a display 502. The current image explains a particular rule or rule combination, indicated in a title 530. As explained above the songs selected/rejected with the current rule and/or other rules explained and/or the total set of rules are shown in a list 505. Further rules are represented as hyperlinks, e.g. if a second hyperlink 532 is clicked, the image of the second rule is displayed i.e. explained, and similarly for the third 534 and fourth hyperlink 536. An “exit” hyperlink may be clicked to leave the tutorial. As is clear to the skilled person hierarchical variants explaining combinations of rules may be constructed similarly. The processing unit 151 may create an optimized hyperlink connection scheme based on the relevances R of the rules of combinations of rules, e.g. the most relevant rule corresponds to the image shown first and the second hyperlink 532 corresponds to the second most relevant rule.

The “accept” button 510 and “reject” button may also be embodied as hyperlinks, taking the user to the next rule explanation theme. Since the apparatus 500 may be a small device with less calculation capabilities than e.g. the home PC, a wired 540 or wireless connection 541 may be present for receiving e.g. the signals of the explanation theme or orders corresponding to rule (parameter) selections from an external processing unit 151 in the case where the rendering unit 178 is incorporated in the apparatus 500 and the rendering is arranged to convert these orders to the appropriate signals. 503 is a mouse button/joystick as known from laptops.

On small screens the image data may be scrolling on a part of the screen with single letters (<A>=accept, <R>=reject, <N>=next rule, and <E>is end constituting a simple interface) functioning as hyperlink buttons.

Multimedia item management behavior explaining units or software can be made industrially, e.g. by a dedicated service institution, and sold (e.g. over internet) to a user. Additionally, the method can be used in industry e.g. in a broadcasting studio by a professional user such as a DJ.

Under computer program product should be understood any physical realization, e.g. an article of manufacture, of a collection of commands enabling a processor—generic or special purpose—, after a series of loading steps to get the commands into the processor, to execute any of the characteristic functions of an invention. In particular the computer program product may be realized as program code, processor adapted code derived from this program code, or any intermediate translation of this program code, on a carrier such as e.g. a disk or other plug-in component, present in a memory, temporarily present on a network connection—wired or wireless—, or program code on paper. Apart from program code, invention characteristic data required for the program may also be embodied as a computer program product.

It should be noted that the above-mentioned embodiments illustrate rather than limit the invention.

The skilled person should realize that different combinations of the components of the tutorial generation unit may be made, each combination being useful in different apparatuses or systems. In particular:

each relevance R attribution strategy can be used as alternative to or in combination with an other strategy;

the processing unit 151 may employ different procedural strategies for the prioritizing selection of multimedia management rules MMR, the way the selected rules MMR1 are sequentially analyzed in the explanation (e.g. by varying their parameters), and the way they are presented to the rendering unit 178 for associating the appropriate signals;

numerous ways of linking signals to rules or combinations of rules may be employed to arrive at a look-and-feel of an explanation theme, in particular the widgets well known from the art of computer interfaces;

additional human generated rule explanation information may be supplied from different sources and introduced in the tutorial by the processing unit 151; and

tutorial generation unit 100, multimedia item management system 130, user preference determination unit 182 (if present) and play-list memory 173 may be in the same device, or different devices, e.g. the first three being embodied in the user's PC, while the play-list memory 173 may be comprised in a portable MP3 player, and storing both the songs, the order to play them, and if required some additional description information.

Any combination of elements can be realized in a single dedicated element.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

The invention can be implemented by means of hardware (e.g. dedicated ASICs or printed circuit boards for each of the units or for subunits) or by means of software running on a generic or special purpose processor.

1. A tutorial generation unit (100) for explaining to a user multimedia management behavior of a multimedia item management system (130) arranged to manage multimedia items (164, 166, 168, 169) according to user preferences by means of at least one multimedia management rule (MMR), the tutorial generation unit (100) comprising:
a processing unit (151), arranged to select at least one selected rule (MMR1) to be explained of the at least one multimedia management rule (MMR), the at least one selected rule (MMR1) being selected depending on a predetermined relevance value (R) indicative of a relevance to the user of the at least one selected rule (MMR1); and
a rendering unit (178), arranged to generate at least one explanation theme (104) comprising at least one audiovisual information presentation signal (108, 110, 112) based on the at least one selected rule (MMR1) to be explained, and arranged to generate a tutorial (102) intended for user observation, the tutorial (102) comprising the at least one explanation theme (104).

2. A tutorial generation unit (100) as claimed in claim 1, in which a user interface unit (150) is comprised, arranged to substitute the at least one information presentation signal (108, 110, 112) of the at least one explanation theme (104) based on user input (in).

3. A tutorial generation unit (100) as claimed in claim 1, in which the rendering unit (178) is arranged to present explanation themes (104) of the type:
a) a movie of pictures to be presented during a predetermined time interval (Dt1), the pictures comprising at least one sub-picture image signal, the at least one sub-picture image signal comprising a graphical representation corresponding the at least one selected rule (MMR1);
b) an information presentation image presenting information corresponding to the at least one selected rule (MMR1), with clickable hyperlink regions (532, 534, 536, 538), which hyperlink regions when clicked initiate the display of a different information presentation image corresponding to a different explanation theme (106);
c) a collection of audio sequentially played snippets, each snippet corresponding to the at least one selected rule (MMR1); and
d) scrolling text containing identifying information of at least one multimedia item selected according to the at least one selected rule (MMR1).

4. A tutorial generation unit (100) as claimed in claim 2, in which the processing unit (151) is further arranged to adapt the at least one multimedia management rule (MMR) of the multimedia item management system (130) based on the user input (in).

5. A tutorial generation unit (100) as claimed in claim 1, in which the processing unit (151) is further arranged to associate a presentation time interval (Dt) with the at least one explanation theme (104), indicating the time interval during which the collection of information presentation signals (108, 110, 112) of the at least one explanation theme (104) are to be presented to the user.

6. A tutorial generation unit (100) as claimed in claim 5, in which the processing unit (151) is further arranged to:
comprise a predetermined total presentation time interval (Ttot); and
allocate explanation themes (104) and associated presentation time intervals (Dt) on the basis of the relevance value (R) of the at least one selected rule (MMR1), and the total presentation time interval (Ttot).

7. A tutorial generation unit (100) as claimed in claim 1, in which the processing unit (151) is further arranged to determine the relevance value (R) of a single selected rule (MMR1) or a combination of selected rules on the basis of one or more of:
a percentage of songs selected or rejected according to the selected rule (MMR1) or rules;
a degree of correspondence between the selected rule (MMR1) or rules and a user preference rule (UPR);
a manually assigned relevance of the selected rule (MMR1) or rules;
a date of introduction or modification of the selected rule (MMR1) or rules;
a date of previous explanation of the selected rule (MMR1) or rules;
a predetermined kind of management action the selected rule (MMR1) or rules predominantly contributes to; and
an origin of a rule.

8. A tutorial generation unit (100) as claimed in claim 1, in which the processing unit (151) is further arranged to explain a subset of the selected rules (MMR1) and/or vary parameters of a subset of the selected rules (MMR1).

9. A tutorial generation unit (100) as claimed in claim 1, in which the processing unit (151) is further arranged to perform a mathematical analysis on an equation (350) specifying a combined action of a set of selected rules (MMR1), in order to explain to a user aspects of the behavior of the equation.

10. A tutorial generation unit (100) as claimed in claim 1, further comprising an interface unit (152) arranged to receive or retrieve information from an external information source (154) of at least one of the types:
human generated information describing a multimedia item;
human generated information describing a multimedia management rule (MMR) or a combination of multimedia management rules; and
human generated information specifying a particular presentation signal related with a multimedia management rule (MMR).

11. A tutorial generation unit (100) as claimed in claim 1, arranged to receive data on user preferences from a user preference determination unit (182).

12. A multimedia management system comprising:
a multimedia item management system (130) arranged to manage multimedia items (164, 166, 168, 169) according to user preferences by means of at least one multimedia management rule (MMR); and
a tutorial generation unit (100) as claimed in claim 1, arranged to explain to a user the behavior of the multimedia item management system (130).

13. A portable apparatus (500) comprising:
a multimedia item management system (130) arranged to manage multimedia items (164, 166, 168, 169) according to user preferences by means of at least one multimedia management rule (MMR); and
a tutorial generation unit (100) as claimed in claim 1, arranged to explain to a user the behavior of the multimedia item management system (130).

14. A method of explaining multimedia management behavior of a multimedia item management system (130) arranged to manage multimedia items (164, 166, 168, 169) according to user preferences by means of at least one multimedia management rule (MMR), comprising:
selecting at least one selected rule (MMR1) to be explained of the at least one multimedia management rule (MMR), the at least one selected rule (MMR1) being selected depending on a predetermined relevance value (R) indicative of a relevance to a user of the at least one selected rule (MMR1); and
generating at least one explanation theme (104) comprising at least one audiovisual information presentation signal (108, 110, 112) based on the at least one selected rule (MMR1) to be explained, and out of that generating a tutorial (102) intended for user observation, the tutorial (102) comprising one or more explanation themes (104, 106).

15. A computer program product comprising code enabling a processor to execute the method as claimed in claim 14.
